(19) United States
(12) Patent Application Publication
(10) Pub. No.: US 2024/0395529 A1
(43) Pub. Date: Nov. 28, 2024

(54) METHOD FOR REDUCING CHARGE AND ION OPTICAL SYSTEM

(71) Applicant: Thermo Fisher Scientific (Bremen) GmbH, Bremen (DE)

(72) Inventors: Dmitry Strelnikov, Bremen (DE); Alexander A. Makarov, Bremen (DE); Jan-Peter Hauschild, Bremen (DE)

(73) Assignee: Thermo Fisher Scientific (Bremen) GmbH, Bremen (DE)

(21) Appl. No.: 18/671,085

(22) Filed: May 22, 2024

(30) Foreign Application Priority Data
May 23, 2023 (GB) 2307689.6

(51) Int. Cl. H01J 49/06; G21K 5/00

(52) U.S. Cl. CPC H01J 49/063; G21K 5/00

(57) ABSTRACT

Methods for reducing charge on a contaminated surface of an ion optical system having a layer of charged contaminant thereon comprise generating charged particles by exciting a radiation source that is distinct from the contaminated surface and neutralising at least a portion of the layer of charged contaminant by causing the charged particles to interact with the layer of charged contaminant. The radiation source comprises an electromagnetic radiation source that emits electromagnetic radiation, and generating the charged particles comprises causing the electromagnetic radiation to interact with the layer of charged contaminant and/or the ion optical system to generate the charged particles; and/or (ii) the radiation source comprises an electron source that emits free electrons. Ion optical systems are configured to reduce charge on a contaminated surface of the ion optical system.

### CROSS REFERENCE TO RELATED APPLICATION

This application claims priority from application GB 2307689.6, filed May 23,2023. The entire disclosure of application GB 2307689.6 is incorporated herein by reference.

### FIELD

The present disclosure concerns ion optical systems and methods for reducing charge on contaminated surfaces of ion optical systems.

### BACKGROUND

Ion optics are used in various analytical instruments to manipulate and transport ions. For example, ion optical systems are widely used in mass spectrometers to focus, transport and eject ions from different regions. Examples of ion optical elements found in typical ion optical systems include ion guides, lenses, carpets and funnels. In these elements, appropriate fields for manipulating ions are applied by electrodes. Ion optical systems typically apply electric and/or magnetic fields within the ion optical system to manipulate charged ions, which experience electric and/or magnetic forces when travelling through such fields. Some ion optical systems perform the sole function of transporting ions from one region to another region, whereas some ion optical systems can trap, transport and/or eject ions at different times.

Ion optics in various systems (e.g. in vacuum systems), including in mass spectrometers, can suffer from contamination caused by deposition of ions on surfaces. These contaminations can become highly charged when ions are deposited. Such contamination can negatively impact the performance of an ion optical system by affecting the fields established within the ion optical system. For example, an accumulation of charge on an electrode in an ion optical system can decrease the transmitted ion current or cause broadening of isolation profiles (for example in quadrupoles).

Attempts to solve these problems often involve venting a system and performing mechanical cleaning of contaminated areas. Other ways for keeping ion optics relatively free from contamination reduce the exposure time (as described in U.S. Pat. No. 9,543,131, for example) or deflect ions to areas where charge accumulation is not as problematic. For example, slits in quadrupole rods can be provided, to keep most of the relevant rod's surface clean, as described in GB-2,555,032. However, a disadvantage of this technique is that geometrical changes of quadrupole surface may affect (e.g. decrease to some extent) the mass resolution of the quadrupole.

Another approach is to add additional mass filters or electrodes to a quadrupole, which filter out unwanted species and reduce contamination of the main quadrupole rods. Examples of this approach can be found in U.S. Pat. Nos. 7,211,788 and 9,929,003.While these solutions are known to work, they still require cleaning of additional rods, albeit at longer time intervals.

It is an object of the present disclosure to address these and other problems with existing ion optical systems.

### SUMMARY

Against this background and in accordance with a first aspect, there is provided a method according to claim 1. An ion optical system according to claim 18 is also provided.

The present disclosure seeks to improve the performance of ion optical systems by partial or full neutralisation of charged contaminated areas. Reducing charge on surfaces of ion optical systems can reduce perturbing potentials caused by charged contaminations. Since perturbing potentials cause deterioration in the performance of ion optical systems, neutralising charges can be highly advantageous.

Embodiments of the present disclosure use charged particles (e.g. protons, electrons, ions and/or anions) to perform such neutralisation. In the case of electrons being used, the electrons may be photoelectrons (i.e. electrons emitted from a material by the photoelectric effect) or other types of electrons, such as thermionic electrons (i.e. electrons emitted by thermionic emission from a material).

Embodiments of the present disclosure can be particularly useful in ion optic systems of high-throughput mass spectrometry systems. Embodiments of the present disclosure are also useful in vacuum conditions and during operation of ion optical systems. For instance, the disclosure provides methods and systems that may allow charged contaminant in ion optical systems to be removed (or at least reduced) periodically.

In accordance with a first aspect, the present disclosure provides a method for reducing charge on a contaminated surface of an ion optical system, the contaminated surface having a layer of charged contaminant thereon. The method comprises: generating charged particles by exciting a radiation source that is distinct from the contaminated surface of the ion optical system; and neutralising at least a portion of the layer of charged contaminant by causing the charged particles to interact with the layer of charged contaminant, wherein (i): the radiation source comprises an electromagnetic radiation source, wherein exciting the radiation source comprises causing the electromagnetic radiation source to emit electromagnetic radiation, and wherein generating the charged particles comprises causing the electromagnetic radiation to interact with the layer of charged contaminant and/or the ion optical system to generate the charged particles; and/or (ii) the radiation source comprises an electron source, wherein exciting the radiation source comprises causing the electron source to emit free electrons. By ‘exciting a radiation source’ it is meant that the radiation source (i.e. the electromagnetic radiation source and/or the electron source) is activated (i.e. turned on) such that it is caused to emit electromagnetic radiation (in the case of the electromagnetic radiation source) and/or free electrons (in the case of the electron source).

According to the first aspect, the electromagnetic radiation may interact with the contaminated surface of the ion optical system to generate the charged particles.

In a second aspect, the disclosure provides an ion optical system configured to reduce charge on a contaminated surface of the ion optical system. The ion optical system comprises: a surface; and a radiation source configured to generate charged particles, wherein the radiation source is distinct from the contaminated surface. The ion optical system is configured to neutralise at least a portion of a layer of charged contaminant on the surface by causing the charged particles to interact with the layer of charged contaminant. The radiation source comprises (i) an electromagnetic radiation source configured to emit electromagnetic radiation that interacts with the layer of charged contaminant and/or the ion optical system to generate the charged particles; and/or (ii) an electron source configured to emit free electrons.

According to the second aspect, the electromagnetic radiation may interact with the surface of the ion optical system to generate the charged particles.

In a third aspect, there is provided an analytical instrument comprising the ion optical system described above, wherein the ion optical system comprises an ion source configured to provide ions to the ion optical system. The radiation source may be distinct from the contaminated surface and from the ion source.

These systems and methods advantageously allow charged contaminant (e.g. accumulated ions) on important surfaces of ion optical systems (e.g. electrodes) to be at least partially neutralised by the charged particles. By neutralising such charges, the deterioration in the performance of ion optical systems that occurs from normal use can be inhibited. These methods can be repeated frequently so throughout can be increased (due to longer intervals being required between manual servicing events). These methods and systems provide relatively low-cost ways of reducing charge in ways that can be retrofitted easily to existing systems through the addition of one or more radiation sources.

The present disclosure also provides a method for reducing contamination of an ion optical system comprising a contaminated surface having a layer of charged contaminant thereon, the method comprising: exciting a source of charged particles to generate charged particles having a kinetic energy of more than 0 eV; and neutralising at least a portion of the layer of charged contaminant by causing the charged particles to enter the layer of charged contaminant. This provides charged particles for at least partially neutralising contaminant in a similar way to the methods described above.

The advantages noted above and various other advantages will become apparent from the present disclosure.

### LISTING OF FIGURES

The present disclosure will now be described by way of example, with reference to the accompanying figures, in which:

FIG. 1 shows an ion optical system in a first embodiment;

FIG. 2 shows an ion optical system in a second embodiment;

FIG. 3 shows a quadrupole ion optical system in a third embodiment;

FIG. 4 shows a quadrupole ion optical system in a fourth embodiment;

FIG. 5 shows the effect of contamination on isolation profiles;

FIG. 6 shows the effect of embodiments of the present disclosure on isolation profiles;

FIG. 7 shows the continuing transmission of ions while embodiments of the present disclosure are implemented;

FIGS. 8A-8B show an arrangement of radiation sources and quadrupole electrodes in a fifth embodiment;

FIGS. 9A-9B demonstrate advantages of the fourth embodiment; and

FIG. 10 shows an analytical instrument in accordance with embodiments of the present disclosure.

### DETAILED DESCRIPTION

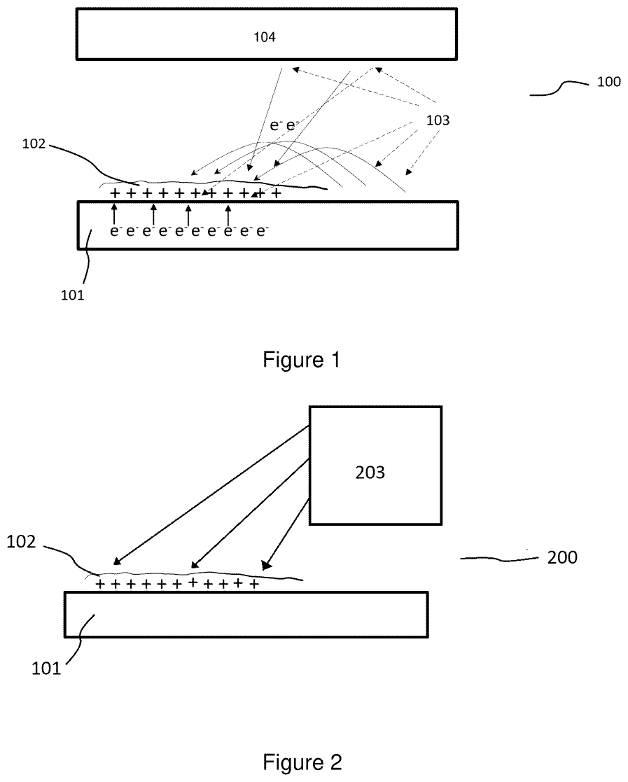

In FIG. 1, a schematic depiction of a first embodiment of an ion optical system 100 is shown. The ion optical system 100 comprises a contaminated surface 101 having a layer of charged contaminant 102 thereon. The layer of charged contaminant 102 is depicted as having positive charges (+) along the contaminated surface 101. The ion optical system 100 also comprises a radiation source 103 configured to generate charged particles. In this embodiment, the charged particles are electrons (depicted as e⁻), but other types of charged particle can be used. The radiation source 103 is distinct from the contaminated surface 101.

In the embodiment of FIG. 1, the radiation source 103 emits electromagnetic radiation, as shown by the arrows with broken lines. The electromagnetic radiation causes the emission of electrons, which are another form of radiation, namely beta radiation. The paths of these electrons are shown with arrows in solid lines.

In use, the ion optical system 100 performs a method for reducing charge on the contaminated surface 101 of the ion optical system 100. Electrons are generated through the photoelectric effect following excitation of the electrons by the radiation source 103. The ion optical system 100 neutralises at least a portion of the layer of charged contaminant 102 by causing the electrons to interact with the layer of charged contaminant 102. This may cause the electrons to neutralise the charge of the layer of charged contaminant 102, thereby partially neutralising the layer of charged contaminant 102.

The radiation source 103 of FIG. 1 generates the electrons through the photoelectric effect and the radiation source 103 is an electromagnetic radiation source. Exciting the radiation source 103 comprises causing the electromagnetic radiation 103 source to emit electromagnetic radiation so as to generate the electrons (i.e. to indirectly generate free electrons by causing the photons to create photoelectrons). The ion optical system 100 comprises photoemitting material and generating the electrons (or other charged particles, if other charged particles are used) comprises causing the electromagnetic radiation to interact with the photoemitting material to generate the electrons. The electromagnetic radiation source may be directed towards the photoemitting material and/or appropriate optical systems may guide the electromagnetic radiation towards the photoemitting material.

In the embodiment of FIG. 1, photoemitting material is present in two distinct elements of the ion optical system 100. A first portion of photoemitting material 104 is distinct from the contaminated surface 101. Moreover, the contaminated surface 101 itself acts a second portion of photoemitting material.

In use, the radiation source 103 creates electrons for discharging and cleaning the contaminated surface 101 by emitting electromagnetic irradiation (e.g. UV-light irradiation) that travels towards and interacts with the portions of photoemitting material. This radiation causes the contaminated surface 101 itself to emit electrons (described herein as the “internal photoelectric effect) and causes the first portion of photoemitting material 104 to emit free electrons (described herein as the “external photoelectric effect”). Thus, in the first embodiment of FIG. 1, the radiation source 103 is configured to generate photoelectrons in two different ways. These photoelectrons then at least partially neutralise the charged contaminant 102, thereby reducing charge on the contaminated surface 101.

In the case of the external photoelectric effect, electrons typically leave metal surfaces (or other photoemitting surfaces) around contaminated areas at relatively low energies and will fly to the charged contaminated area being attracted just by charge, as depicted in FIG. 1. The curved paths of electrons in FIG. 1 show the way in which free electrons can be directed towards the charged contaminant 102.

In some cases, relatively high voltages may be present on electrodes and photoelectrons can be accelerated and create also secondary electrons, desorbed neutrals, vacuum ultraviolet (VUV) and x-ray bremsstrahlung. Thus, the disclosure also provides ways of cleaning the contaminated surface 101 using bombardment by fast electrons. Hence, in general terms, the ion optical systems of the present disclosure may comprise one or more electrodes and the methods described herein may comprise applying a voltage to at least one electrode of the ion optical system to accelerate the charged particles (e.g. free electrons) and thereby generate additional radiation for neutralising the at least a portion of the layer of charged contaminant. This can enhance the neutralisation of charged contaminant. In some cases, the methods may involve applying a magnetic field in the ion optical system to guide the electrons or other charged particles towards the layer of charged contaminant. This can also improve the neutralisation of charge.

In the case of the internal photoelectric effect, mobile electrons from photoemitting material (e.g. metal) under the layer of contaminant 102 are transferred to the contaminated surface 101. Some photons may reach the contaminated areas after being reflected from surrounding surfaces (e.g. surrounding metal surfaces). The thickness of the layer is preferably thin enough to be transparent for the electromagnetic radiation (e.g. to UV photons). Typical thicknesses may be more than 5 nm up to few micrometres (e.g. 1-2 μm). Such layers can be fully or at least partially neutralised using the present disclosure. In some cases, where a layer of contaminant has a thickness of 1-2 μm, the layer may be almost fully neutralised.

In preferred embodiments, the photoemitting material is a metal material. Metal materials may have appropriate work functions that permit the generation of a large enough number of electrons to perform neutralisation. Therefore, metals can be a good source of electrons. However, other materials may be used.

In some embodiments, the photoemitting material comprises the contaminated surface of the ion optical system. The contaminated surface may be, for example, a surface of an electrode of the ion optical system. Electrodes in ion optical systems may become contaminated during normal operations. Some embodiments of the present disclosure exploit the fact that electrodes can also act as good sources of electrons or other charged particles that can be used to neutralise charged contaminant.

In FIG. 1, the first portion of photoemitting material 104 is shown as being a generic photoemitting material. It will be appreciated that the first portion of photoemitting material 104 may be an electrode of an ion optical system or the first portion of photoemitting material 104 may be another photoemitting surface near the contaminated surface 101. In some cases, the ion optical system may comprise a plurality of electrodes and the contaminated surface may be one of the plurality of electrodes and the photoemitting material may be another of the plurality of electrodes (or some other photoemitting surface in the ion optical system). Each electrode in the plurality of electrodes may be contaminated and each electrode in the plurality of electrodes may be configured to provide electrons for cleaning another electrode in the plurality of electrodes. Thus, the ion optical system may comprise: one or more electrodes that are distinct from at least a portion of the photoemitting material; and/or one or more electrodes that are at least a portion of the photoemitting material.

The electromagnetic radiation sources described herein may comprise ultraviolet (UV) radiation sources. UV light may provide photons having appropriate energies to cause the emission of electrons from common photoemitting materials. The wavelength of light used may be varied depending on the work function of the photoemitting material. The electromagnetic radiation sources described herein may comprise one or more light emitting diodes (LEDs). LEDs are widely available and can provide photons having appropriate energies for generating electrons. However, other sources of photons may be provided.

In the first embodiment shown in FIG. 1, the radiation source 103 is configured to generate photoelectrons in two different ways. However, other ways of providing electrons are possible.

In FIG. 2, a schematic depiction of a second embodiment of an ion optical system 200 is shown. This embodiment is similar to the ion optical system 100 of FIG. 1 in that a contaminated surface 101 has a layer of charged contaminant 102 thereon. The contaminated surface 101 and the charged contaminant 102 are as described above in relation to FIG. 1.

The radiation source 203 of the ion optical system 200 of FIG. 2 differs from that of the ion optical system 100 of FIG. 1. In this second embodiment, the radiation source 203 emits free electrons (i.e. directly generates free electrons) and so is a source of beta radiation, rather than a source of electromagnetic radiation as in FIG. 1. When the radiation source 203 of the ion optical system 200 is excited, the ion optical system 200 neutralises at least a portion of the layer of charged contaminant 102 by causing the free electrons emitted by the radiation source 203 to interact with the layer of charged contaminant 102. Hence, charge on the contaminated surface 101 is reduced. Accelerated free electrons can also evaporate contaminant 102, which may be beneficial in cases, when evaporated material will not coat other crucial for a proper operation surfaces.

The radiation source 203 can be various types of radiation source. For example, free electrons can be generated by thermal emission of electrons from a hot filament. Various materials such as tungsten and rhenium may be used. In some embodiments, field emission sources may be used.

The systems of FIGS. 1 and 2 may be combined. For example, at least one electromagnetic radiation source (e.g. 103) and at least one beta radiation source (e.g. 203) may be provided in a single system. Other radiation sources may also be present.

Returning to the general terms used previously, in some embodiments the radiation source comprises an electron source (i.e. the charged particles may be electrons) and exciting the radiation source comprises causing the electron source to emit free electrons. In such cases, the radiation source is therefore a beta radiation source. The electron source is preferably distinct from the contaminated surface of the ion optical system and the electron source may comprise a filament. Exciting the radiation source may comprise heating the filament to emit free electrons. Various materials for the filament can be chosen, depending on the nature of the contaminant and the energy of electrons that is required.

While electrons are used as charged particles for reducing charge in the embodiments described above, other charged particles can be used. For example, while certain embodiments are described in terms of free electrons doing the discharging, discharging could in fact be performed by any type of charge carrier, such as protons, electrons, ions and/or anions. Therefore, some embodiments may include generating charged particles using a source of protons, ions and/or anions and causing those charged particles to interact with a layer of contaminant.

In some embodiments, charged particles may be activated by electromagnetic radiation. This activation may cause the charged particles to be mobilised and the charged particles may be attracted to charged molecules, thereby neutralising those molecules. For instance, mobile protons may perform charging, or mobile electrons or ions/anions within deposits themselves may perform discharging. These mechanisms may be performed in addition to or instead of the mechanisms described above in relation to FIGS. 1 and 2.

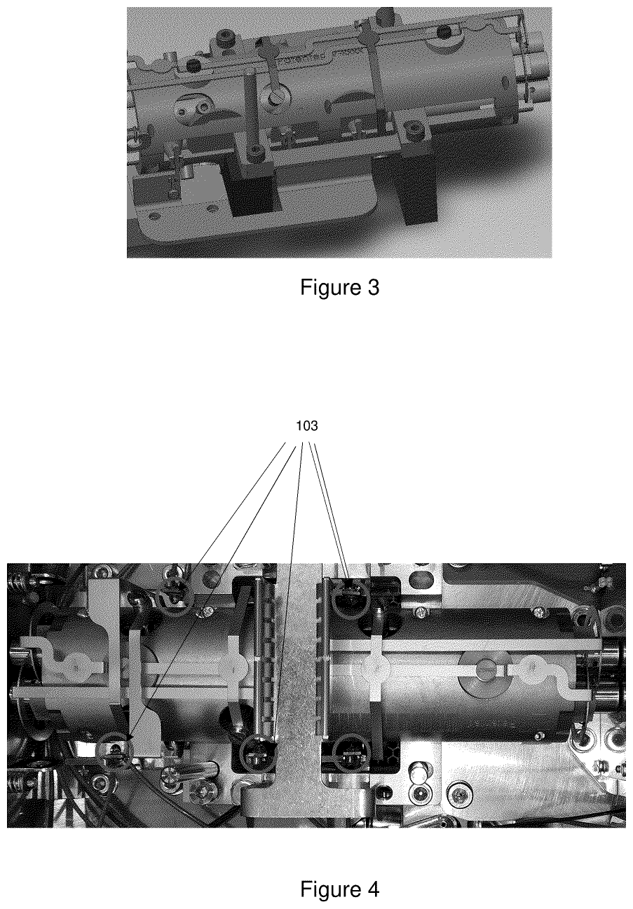

Turning next to FIGS. 3 and 4, third and fourth embodiments of the present disclosure have been applied in quadrupole mass filter (which may be described as a quadrupole ion optical system) inside a Thermo Scientific™ Orbitrap Exploris™ 480 mass spectrometer. Six UV LEDs, 265 nm emission wavelength (4.68 eV), are placed on opposite sides of a quadrupole such that emitted UV light penetrates through openings (slits) in the quadrupole housing and falls partly on internal surfaces of the quadrupole rods. Slits in the quadrupole housing are a construction feature of many known quadrupoles, so slits already be present in existing ion optical systems without any modifications being required. This may allow for easy retrofitting of embodiments of the present disclosure.

In a general sense, the ion optical systems described herein may comprise a housing having one or more openings (e.g. slits, which are elongate openings that are longer than they are wide). The methods described herein may further comprise causing the radiation (e.g. the electromagnetic radiation in FIG. 1 and FIGS. 3 and 4, or the free electrons in FIG. 2) to pass through the one or more openings. When the radiation is electromagnetic radiation, this may cause the electromagnetic radiation to interact with the photoemitting material to generate electrons. Electrons or other charged particles may also be made to pass through such openings (slits) in the housing.

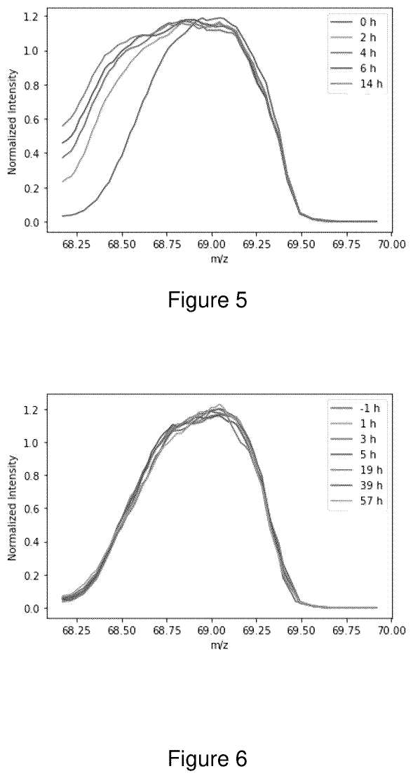

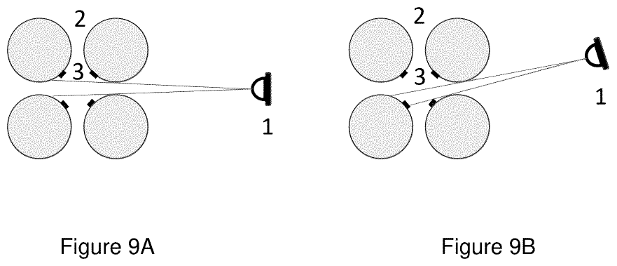

In FIGS. 3 and 4, the UV LEDs are slightly displaced up or down relative to the ion axis plane in order to increase efficiency of the rods' irradiation, as explained in more detail in relation to FIGS. 8 and 9. The quadrupole rods have been previously contaminated with ubiquitin. Without use of embodiments of the present disclosure, further deposition of ubiquitin leads to fast charging of the contaminated areas, which causes a broadening of isolation profiles. The broadening can be observed with a FlexMix calibration solution at the low m/z 69, as shown in FIG. 5. Different curves correspond to different exposure times of the quadrupole to ubiquitin ions. Direct infusion of concentrated ubiquitin solution, corresponding to 10 μl/min or 250 ng/min ubiquitin flow, is used for these data sets. In FIG. 5, broadening of the m/z 69 isolation profile is seen after the first two hours of operation.

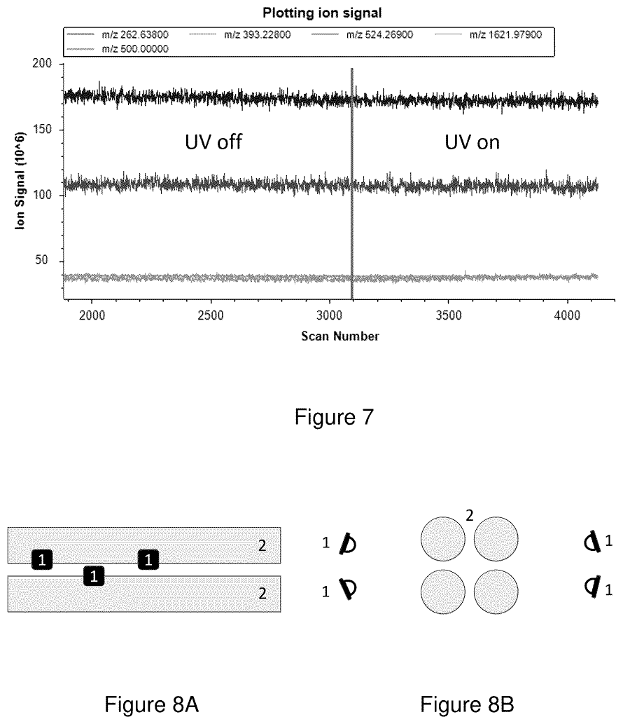

If deposition of ubiquitin is repeated with a UV LED turned on, broadening of the isolation profiles is not observed, even after 57 hours, as shown in FIG. 6. Notably, the quadrupole continues to run and transmits ions as usual, despite the presence of photoelectrons, as shown in FIG. 7. Ions and electrons do not interfere, because their extremely low concentrations makes the probability of interaction infinitesimal over the residence time of ions in the quadrupole (which is typically on the order of microseconds). Quadrupole neutralisation and operation periods may be varied, if necessary. Hence, it can be seen that embodiments of the present disclosure may allow considerable increases in intervals between servicing or cleaning.

Turning next to FIGS. 8A-8B, an arrangement of radiation sources and quadrupole electrodes is shown in a fifth embodiment. The arrangement of FIGS. 8A-8B can be implemented in any of the embodiments described previously, including in embodiments that use the internal and/or external photoelectric effect. FIG. 8A is a side view and FIG. 8B is a front view. In FIGS. 8A-8B, a plurality of radiation sources 1 are shown facing towards and positioned close to quadrupole rods 2. In FIGS. 8A-8B, it can be seen that the radiation sources are spaced apart along the length of the rods. That is, each radiation source is at a different distance along the length of the rods. Moreover, the LEDs are offset from the axis of the rods. The radiation sources 1 are preferably LEDs, such as UV LEDs, although other radiation sources could be provided in a similar arrangement.

FIGS. 9A-9B show. an advantage of the arrangement of FIGS. 8A-8B. FIG. 9A shows a horizontal arrangement of radiation sources while FIG. 9B shows a displaced arrangement of radiation sources. Here are figures schematically showing light penetration inside a quadrupole. In FIGS. 9A and 9B, the radiation sources 1 face towards the quadrupole rods 2 which have contaminant 3 thereon (shown as small rectangles). As can be seen in FIG. 9B, a greater surface area of the contaminated areas is irradiated using the displaced arrangement in FIG. 9B.

In the case where an ion optical system comprises a pair of electrodes (or any other pair of contaminated surfaces), there will exist a plane bisecting the pair of electrodes. As shown in FIGS. 9A-9B, it can be advantageous for one or more (i.e. a plurality of) radiation sources to be displaced from (i.e. not positioned on) that plane bisecting a pair of electrodes. This may increase the area of the electrodes that is irradiated and hence neutralised. In some embodiments, ion optical systems may comprise a plurality of pairs of electrodes and a plurality of radiation sources, wherein each radiation source is displaced from a plane bisecting a respective pair of electrodes. It may be advantageous for no radiation source to be on a plane bisecting any of the pairs of electrodes.

The embodiments described herein can be applied to component(s) within an analytical instrument. Indeed, the ion optical systems described herein can be part of an analytical instrument, the analytical instrument comprising an ion source configured to provide ions to the ion optical system. The methods described herein of reducing charge contamination of a contaminated surface may be applied to any component of the analytical instrument (except the ion source).

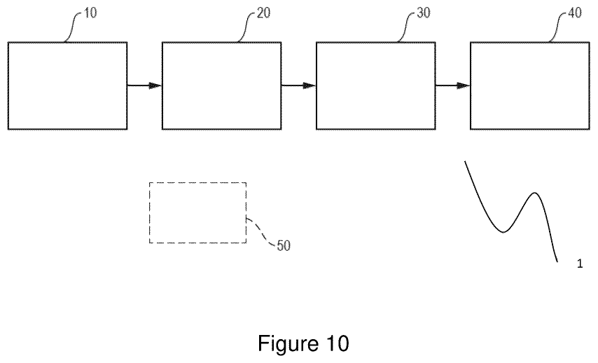

A schematic diagram of an exemplary analytical instrument 1 is shown in FIG. 10. As schematically shown in FIG. 10, the exemplary analytical instrument 1 includes an ion source 10, a mass filter 20, a fragmentation device 30, and a mass analyser 40. It should be noted that FIG. 10 is merely schematic, and that the instrument can, and in embodiments does, include any number of one or more additional components, such as ion optical devices. For example, the analytical instrument 1 may include one or more ion transfer stage(s) arranged between any of the illustrated components, e.g. including an atmospheric pressure interface configured such that some or all of the ions can be transmitted appropriately through the instrument 1. The ion transfer stage(s) may include any suitable number and configuration of ion optical devices, for example optionally including one or more ion guides, lenses and/or other ion optical devices.

The ion optical system described herein may comprise any of the described components of the analytical instrument 1 (except the ion source 10) and, similarly, the contaminated surface may be a surface of any of the described components of the analytical instrument 1 (except the ion source 10). Similarly, the method of reducing charge on a contaminated surface of an optical system described herein can be applied to a surface of any components of the analytical instrument 1 (except the ion source 10). In particular, the ion optical system may comprise the mass filter 20 and/or the fragmentation device 30 and/or at least a part of the mass analyser 40 and/or other optical device(s) of the analytical instrument 1. The surface of the ion optical system that is contaminated may be a surface of the mass filter 20 and/or a surface of the fragmentation device 30 and/or a surface of the mass analyser 40 and/or a surface of other optical device(s) of the analytical instrument 1. By way of example, the contaminated surface may be a surface of an electrode of a component of the analytical instrument 1. The method of reducing charge on a contaminated surface described herein may be applied most usefully to the mass filter 20 of the analytical instrument 1, since the mass filter 20 is particularly prone to contamination. Similarly, in preferred embodiments, the ion optical system comprises the mass filter 20 of the analytical instrument 1 and the contaminated surface is a surface of the mass filter 20.

The ion source 10 is configured to generate ions from a sample. The ion source 10 may be coupled to a separation device (not shown) such as a liquid chromatography (LC) separation device, a gas chromatography (GC) separation device, or a capillary electrophoresis separation device, and the like, such that the sample which is ionised in the ion source 10 comes from the separation device. The ion source 10 can be any suitable ion source, such as an electrospray ionisation (ESI) ion source, an atmospheric pressure ionisation (API) ion source, a chemical ionisation ion source, an electron impact (EI) ion source, or similar. Numerous other types of ionisation are possible.

As discussed above, the methods of the present disclosure and the ion optical system of the present disclosure employ a radiation source (not shown in FIG. 10). The radiation source may comprise an electromagnetic radiation source, as exemplified by FIGS. 1, 3 and 4 and/or a free electron source, as exemplified by FIG. 2. The radiation source is distinct from the ion source 10 of the analytical instrument 1. The radiation source is distinct from the contaminated surface of the component forming part of the ion optical system. As the radiation source of the ion optical system is distinct from the ion source 10 of the analytical instrument 1, neutralising at least a portion of the layer of charged contaminant does not require interruption of ion flow from the ion source 10. Indeed, the ion source 10 can be operated during excitation of the radiation source and neutralisation of a portion of the layer of charged contaminant by interaction with the charged particles generated by the excitation. In other words, neutralising at least a portion of the layer of charged contaminant can be performed during ion flow from the ion source 10.

As discussed in the context of the embodiments of FIGS. 3 and 4, the radiation source may optionally be arranged outside a housing surrounding component(s) of the analytical instrument where the radiation, free electrons or other charged particles pass through the opening(s) in the housing to neutralise a contaminated surface of the component(s) within the housing. Alternatively, as described in the context of the embodiments of FIGS. 8A-8B and 9A-9B, the radiation source may be positioned close to the component(s) of the analytical instrument. Optionally, multiple radiation sources may be employed, as exemplified by FIGS. 8A-8B and 9A-9B.

The analytical instrument 1 may additionally or alternatively include an ion separation device (not shown) arranged downstream of the ion source and configured to separate samples ions according to a physico-chemical property. For example, the instrument 1 may include an ion mobility (IM) separator, a differential ion mobility separator, or a device configured to separate ions according to their mass to charge ratio (m/z)). The ion optical system described herein may comprise such an ion separation device and the contaminated surface may be a surface of the ion separation device.

The mass filter 20 is arranged downstream of the ion source 10 and is configured to receive ions from the ion source 10 (optionally via the ion separation device). The mass filter 20 is configured to filter the received ions according to their mass to charge ratio (m/z). The mass filter 20 may be configured such that received ions having m/z within an m/z transmission window (or “isolation window”) of the mass filter are onwardly transmitted by the mass filter, while received ions having m/z outside the m/z transmission window are attenuated by the mass filter, i.e. are not onwardly transmitted by the mass filter. The width and/or the centre m/z of the transmission window may be controllable (variable), e.g. by suitable control of RF and/or DC voltage(s) applied to electrodes of the mass filter 20. Thus, for example, the mass filter 20 may be operable in a transmission mode of operation, whereby most or all ions within a relatively wide m/z window are onwardly transmitted by the mass filter 20, and a filtering mode of operation, whereby only ions within a relatively narrow m/z window (centred at a desired m/z) are onwardly transmitted by the mass filter 20. The mass filter 20 can be any suitable type of mass filter, such as a quadrupole mass filter. FIGS. 3 and 4 are examples where the embodiments of the claimed invention have been applied to a quadrupole mass filter.

The fragmentation device 30 is arranged downstream of the mass filter 20 and is configured to receive most or all ions transmitted by the mass filter 20. The fragmentation device 30 may be configured to selectively fragment some or all of the received ions, i.e. so as to produce fragment ions. The fragmentation device 30 may be operable in a fragmentation mode of operation, whereby most or all received ions are fragmented so as to produce fragment ions (which may then be onwardly transmitted from the fragmentation device 30), and a non-fragmentation mode of operation, whereby most or all received ions are onwardly transmitted without being (deliberately) fragmented. It would also be possible for a non-fragmentation mode of operation to be implemented by causing ions to bypass the fragmentation device 30. The fragmentation device 30 may also be operable in one or more intermediate modes of operation, e.g. whereby the degree of fragmentation is controllable (variable). The fragmentation device 30 can also be operable in higher order (MS^{N}) fragmentation modes of operation, e.g. whereby fragment ions are further fragmented one or more times by the fragmentation device 30.

The fragmentation device 30 can be any suitable type of fragmentation device, such as for example a collision induced dissociation (CID) fragmentation device, an electron induced dissociation (EID) fragmentation device, a photodissociation fragmentation device, and so on. Numerous other types of fragmentation are possible.

The mass analyser 40 is arranged downstream of the fragmentation device 30 and is configured to receive ions from the fragmentation device 30. Thus, the mass analyser 40 may receive unfragmented precursor ions and/or fragment ions, depending on the mode of operation of the fragmentation device 30. The mass analyser 40 is configured to analyse the received ions so as to determine their mass to charge ratio (m/z) and/or mass, i.e. to produce a mass spectrum of the ions. The mass analyser 40 can be any suitable type of mass analyser, such as an ion trap mass analyser, an electrostatic orbital trap mass analyser (such as an Orbitrap™ FT mass analyser as made by Thermo Fisher Scientific), a time-of-flight (ToF) mass analyser such as a multi-reflecting time-of-flight (MR-ToF) mass analyser, or a quadrupole mass analyser. Numerous other types of mass analyser are possible.

In some embodiments, the instrument 1 may include more than one mass analyser. For example, the instrument 1 may be a dual mass analyser hybrid mass spectrometer of the type described in EP 3,410,463, the contents of which are incorporated herein by reference.

As also shown in FIG. 10, the instrument 1 is under the control of a control unit 50, such as an appropriately programmed computer, which controls the operation of various components of the instrument and, for example, sets the voltages to be applied to the various components of the instrument. The control unit 50 may also receive and process data from various components including the analyser(s). The control unit 50 may be configured to control the operation of the ion source 10 and the operation of the radiation source independently.

The instrument may be operable in various mode of operation. In particular, the instrument may be a tandem mass spectrometer operable in an MS1 mode of operation and an MS2 mode of operation.

In the MS1 (or “full mass scan”) mode of operation, the mass filter 20 is operated in its transmission mode of operation and the fragmentation device 30 is operated in its non-fragmentation mode of operation, e.g. so that a wide m/z range (e.g. full mass range) of unfragmented (“precursor” or “parent”) ions are analysed by the analyser 40 to produce an MS1 spectrum.

In the MS2 mode of operation, the mass filter 20 is operated in its filtering mode of operation and the fragmentation device 30 is operated in its fragmentation mode of operation, e.g. so that a selected narrow m/z range of precursor ions are fragmented and the resulting fragment (“product” or “daughter”) ions are analysed by the analyser 40 to produce an MS2 spectrum.

The instrument may also be operable in one or more higher order fragmentation modes of operation, such as for example an MS3 mode of operation, whereby precursor ions are fragmented, at least some of the resulting fragment ions are themselves fragmented, and the second-generation fragment ions (“granddaughter ions”) are analysed by the analyser 40 produce an MS3 spectrum. In general, the instrument may be operable in any order of fragmentation mode of operation, i.e. in an MS^{N} mode of operation where N≥2.

It will be understood that many variations may be made to the above systems and methods whilst retaining the advantages noted previously. For example, where specific components have been described, alternative components can be provided that provide the same or similar functionality.

While the disclosure primarily discusses positively-charged contamination, negatively charged contamination may be neutralised by electron bombardment and/or directly by electromagnetic radiation (e.g. UV light). Hence, in the methods and systems described herein, the layer of charged contaminant may be a layer of positively-charged contaminant or a layer of negatively-charged contaminant.

Embodiments of the disclosure can be used in various ion optical systems without changing the geometry of the ion optics, just by adding radiation sources (e.g. electromagnetic radiation sources, such as UV sources, or filaments) at appropriate positions. Therefore, the disclosure provides a universal solution in comparison to existing solutions. Moreover, embodiments of the present disclosure are relatively low-cost and LEDs can be operated far below their nominal power in order to extend their lifetimes.

Embodiments of the present disclosure can be used in various ion optical systems, such as ion guides and ion traps (e.g. quadrupoles). In some cases, magnetic fields can be used to guide electrons. Different sources of electromagnetic radiation (e.g. UV light) may be placed outside a vacuum region, with radiation entering via optic fibres or windows.

Embodiments of the disclosure can use various numbers of radiation sources. Some embodiments use 6 LEDs, but it will be recognised that the number, type and arrangement of the radiation sources can be varied.

Any contaminated surfaces of RF and/or DC ion optics such as in quadrupoles, can be treated with embodiments of the present disclosure, including when such systems are filled with gas. In some embodiments, gas pressures could reach (e.g. be adjusted to reach) the level at which the mean free path of electrons becomes significantly smaller than the smallest gap between the closest electrodes of different potentials. Hence, in generalised terms, embodiments of the disclosure may comprise controlling a gas pressure within the ion optical system (e.g. within the housing of a trap, such as a quadrupole) such that a mean free path of electrons is less than a spacing between electrodes (e.g. the closest distance between adjacent electrodes) in the ion optical system. The gas pressures used are more relevant for the external photoelectric effect as gas pressure does not play a significant role for the internal photoelectric effect. Even at higher gas pressures, electrons with certain energies can reach the contaminant after multiple scatterings from charged areas.

As mentioned previously, the energy of the electrons may be varied depending on the particular contaminant and the particular contaminated surface. Where the photoelectric effect is used, the energy of electromagnetic radiation may be selected such that electrons have at least the minimum energy (e.g. the work function) required to leave the photoemitting material (e.g. solid metal). Electrons may be accelerated by RF and/or DC voltages of electrodes and/or influenced also by potentials due to impurities. Electron energies may vary from 0 eV to 3 keV (or up to 2 keV, or 1 keV, etc.). Other values can be used depending on the circumstances. Photon energies could be set as the work function of the photoemitting material plus or minus up to 2 eV, or up to 1 eV, to account for the electronic distribution at the Fermi energy and possible effects of adsorbates.

The work function is 4.4-4.5 eV for stainless steel and 4.5-5 eV for invar (Fe—36Ni), depending on surface purity and measurement technique. Photoelectrons from gold coated invar may also be used and various work functions of 4.8-5.4 eV are reported. Thus, in some embodiments, the electrons may have an energy that is greater than the work function of the material from which the photoemitting surface is formed.

In some embodiments, electrodes (e.g. rods) may be coated with metal having a lower work function to facilitate the production of photoelectrons. For instance, in general terms, at least one electrode (and optionally the contaminated surface) of an ion optical system may be a coated electrode that is at least partially (or fully) coated in a material having a lower work function than the material of the coated electrode. While tunnelling currents may play a role for distances below 5 nm in proteins, since the work function of invar (a common material) is about 4.5-5 eV, substantial neutralisation through tunnelling is unlikely for contamination thicknesses >5 nm. In any event, at least some electrons may be transferred from a contaminated surface into a layer of contaminant without strictly being free electrons; such electrons are mobile electrons.

It will be recognised that the methods and systems described herein may be used repeatedly. For example, an ion optical system may be at least partially neutralised repeatedly. Therefore, the present disclosure also provides, in generalised terms, a method of operating an ion optical system, comprising: introducing a sample into the ion optical system; manipulating and ejecting the sample using the ion optical system; and performing any of the methods for reducing charge described herein on the ion optical system. These steps may be repeated one or more times. For example, these steps may be repeated at regular intervals or between each loading of a sample. In some cases, the methods may be performed continuously while a sample is being trapped, transported or otherwise manipulated. The use of these methods can ensure that ion optical system performance is maintained.

Each feature disclosed in this specification, unless stated otherwise, may be replaced by alternative features serving the same, equivalent or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and, where the context allows, vice versa. For instance, unless the context indicates otherwise, a singular reference herein including in the claims, such as “a” or “an” (such as an electrode or a surface) means “one or more” (for instance, one or more electrodes, or one or more surfaces). Throughout the description and claims of this disclosure, the words “comprise”, “including”, “having” and “contain” and variations of the words, for example “comprising” and “comprises” or similar, mean that the described feature includes the additional features that follow, and are not intended to (and do not) exclude the presence of other components.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

Any steps described in this specification may be performed in any order or simultaneously unless stated or the context requires otherwise. Moreover, where a step is described as being performed after a step, this does not preclude intervening steps being performed.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

Moreover, the disclosure also provides methods of manufacturing and using the systems described herein. For example, methods of manufacturing any of the systems described herein are provided, as are methods of using the systems described herein.

1. A method for reducing charge on a contaminated surface of an ion optical system, the contaminated surface having a layer of charged contaminant thereon, the method comprising:
generating charged particles by exciting a radiation source that is distinct from the contaminated surface of the ion optical system; and
neutralising at least a portion of the layer of charged contaminant by causing the charged particles to interact with the layer of charged contaminant;
wherein the radiation source comprises one or more of an electron source, wherein exciting the radiation source comprises causing the electron source to emit free electrons and an electromagnetic radiation source, wherein exciting the radiation source comprises causing the electromagnetic radiation source to emit electromagnetic radiation, and wherein generating the charged particles comprises causing the electromagnetic radiation to interact with the layer of charged contaminant and/or the ion optical system to generate the charged particles.

2. The method of claim 1, wherein the ion optical system comprises a photoemitting material and wherein generating the charged particles comprises causing the electromagnetic radiation to interact with the photoemitting material to generate the charged particles.

3. The method of claim 2, wherein the photoemitting material is a metal material.

4. The method of claim 2, wherein the photoemitting material comprises the contaminated surface of the ion optical system.

5. The method of claim 2, wherein the contaminated surface is a surface of an electrode of the ion optical system.

6. The method of claim 2, wherein at least a portion of the photoemitting material is distinct from the contaminated surface.

7. The method of claim 2, wherein the photoemitting material generates electrons and/or protons when photons from the electromagnetic radiation source interact with the photoemitting material.

8. The method of claim 2, wherein the ion optical system comprises a housing having one or more openings and the method further comprises causing the electromagnetic radiation to pass through the one or more openings to interact with the photoemitting material to generate the charged particles.

9. The method of claim 2, wherein the electromagnetic radiation source comprises an ultraviolet (UV) radiation source; and/or wherein the electromagnetic radiation source comprises one or more light emitting diodes (LEDs).

10. The method of claim 1, wherein the electron source is distinct from the contaminated surface of the ion optical system; and/or wherein the electron source comprises a filament, wherein exciting the radiation source comprises heating the filament to emit the free electrons.

11. The method of claim 1, wherein the ion optical system comprises one or more electrodes and wherein the contaminated surface is a surface of the one or more electrodes.

12. The method of claim 1, wherein the method further comprises controlling a gas pressure within the ion optical system such that a mean free path of electrons is less than a spacing between electrodes in the ion optical system.

13. The method of claim 1, wherein the ion optical system comprises a pair of electrodes and the radiation source is displaced from a plane bisecting the pair of electrodes.

14. The method of claim 1, wherein the ion optical system comprises a plurality of pairs of electrodes and a plurality of radiation sources, wherein each radiation source is displaced from a plane bisecting a respective pair of electrodes.

15. The method of claim 1, wherein the ion optical system comprises one or more electrodes, further comprising applying a voltage to at least one electrode of the ion optical system to accelerate the charged particles and thereby generate additional radiation for neutralising the at least a portion of the layer of charged contaminant.

16. The method of claim 1, further comprising applying a magnetic field in the ion optical system to guide the charged particles towards the layer of charged contaminant.

17. The method of claim 1, wherein the ion optical system is a quadrupole electrode system and the charged particles comprise any one or more of protons, electrons, ions, and anions.

18. The method of claim 1, wherein the layer of charged contaminant is a layer of positively-charged contaminant.

19. The method of claim 1, wherein the ion optical system is part of an analytical instrument comprising an ion source configured to provide ions to the ion optical system, wherein the radiation source is distinct from the contaminated surface and from the ion source.

20. The method of claim 1, wherein the ion optical system is part of an analytical instrument comprising an ion source configured to provide ions to the ion optical system, wherein the step of neutralising at least a portion of the layer of charged contaminant by causing the charged particles to interact with the layer of charged contaminant is performed without requiring interruption of ion flow from the ion source.

21. A method of operating an ion optical system, comprising:
(i) introducing a sample into the ion optical system;
(ii) manipulating and ejecting the sample using the ion optical system; and
(iii) performing the method for reducing charge of claim 1 on the ion optical system; and
selectively repeating steps (i), (ii) and (iii) one or more times.

22. An ion optical system configured to reduce charge on a contaminated surface of the ion optical system, the ion optical system comprising:
a surface; and
a radiation source configured to generate charged particles, wherein the radiation source is distinct from the surface; and
wherein the ion optical system is configured to neutralise at least a portion of a layer of charged contaminant on the surface by causing the charged particles to interact with the layer of charged contaminant,
wherein (i): the radiation source comprises an electromagnetic radiation source configured to emit electromagnetic radiation that interacts with the layer of charged contaminant and/or the ion optical system to generate the charged particles; and/or
(ii) the radiation source comprises an electron source configured to emit free electrons.

23. The ion optical system of claim 22, wherein the ion optical system comprises a photoemitting material and wherein the electromagnetic radiation source is configured to emit electromagnetic radiation that interacts with the photoemitting material to generate the charged particles.

24. The ion optical system of claim 23, further comprising a housing defining one or more openings situated so that the electromagnetic radiation passes through the one or more openings to interact with the photoemitting material to generate the charged particles.
